(19) United States
(12) Patent Application Publication
(10) Pub. No.: US 2021/0245575 A1
(43) Pub. Date: Aug. 12, 2021

(54) AIRFLOW GENERATING DEVICE

(71) Applicant: DENSO CORPORATION, Kariya-city (JP)

(72) Inventors: Etsuro YOSHINO, Nisshin-city (JP); Yasuhiro TAKEUCHI, Nisshin-city (JP); Yuuji OKAMURA, Kariya-city (JP); Jun YAMAOKA, Kariya-city (JP); Masaharu SAKAI, Kariya-city (JP); Yusuke KOMATSUBARA, Kariya-city (JP); Kazushi SHIKATA, Kariya-city (JP); Yasuhiko NIIMI, Kariya-city (JP)

(21) Appl. No.: 17/240,725

(22) Filed: Apr. 26, 2021

Related U.S. Application Data
(63) Continuation of application No. PCT/JP2019/043684, filed on Nov. 7, 2019.

(30) Foreign Application Priority Data
Nov. 19, 2018 (JP) 2018-216357

(51) Int. Cl. B60H 1/00

(52) U.S. Cl. CPC B60H 1/00828; B60H 1/00428

(57) ABSTRACT

An airflow generating device includes an airflow generating portion, a duct, and a controller. The airflow generating portion is configured to generate an airflow. The duct is configured to guide the airflow to a blowing outlet through which the airflow is blown out toward a passenger in a vehicle cabin. The controller is configured to cause the airflow to be intermittently blown out through the blowing outlet by controlling a frequency of a pulse voltage applied to the air flow generating portion and a duty ratio of a pulse width to a pulse period of the pulse voltage. The controller is configured to control the duty ratio and the frequency of the voltage such that the airflow is blown out through the blowing outlet at a speed between a predetermined lower limit, inclusive, and a maximum lower limit, non-inclusive, which is greater than the lower limit.

### CROSS REFERENCE TO RELATED APPLICATION

The present application is a continuation application of International Patent Application No. PCT/JP2019/043684 filed on Nov. 7, 2019, which designated the U.S. and claims the benefit of priority from Japanese Patent Application No. 2018-216357 filed on Nov. 19, 2018. The entire disclosures of all of the above applications are incorporated herein by reference.

### TECHNICAL FIELD

The present disclosure relates to an airflow generating device.

### BACKGROUND

An automobile air conditioning device includes an awakening detector and an air conditioner. The awakening detector is configured to detect a level of arousal of a driver for a vehicle.

### SUMMARY

An airflow generating device includes an airflow generating portion, a duct, and a controller. The airflow generating portion is configured to generate an airflow. The duct is configured to guide the airflow generated by the airflow generating portion to a blowing outlet through which the airflow is blown out toward a passenger in a vehicle cabin. The controller is configured to cause the airflow to be intermittently blown out through the blowing outlet by controlling a frequency of a pulse voltage applied to the air flow generating portion and a duty ratio of a pulse width to a pulse period of the pulse voltage.

### BRIEF DESCRIPTION OF DRAWINGS

FIG. 1 is a diagram illustrating an overall configuration of an air conditioner of a first embodiment.

FIG. 2 is a diagram illustrating a state in which a controller controls the airflow to intermittently blow out through a face blowing outlet, a foot blowing outlet, and a defroster blowing outlet.

FIG. 3 is a time chart of a pulse voltage applied to a motor configured to rotate a fan and a speed of an airflow blown out through a face blowing outlet.

FIG. 4 is a diagram illustrating a speed distribution of a comparative example configured to continuously blow out an airflow through a blowing outlet.

FIG. 5 is a diagram illustrating a speed distribution of the air conditioner of this embodiment configured to intermittently blow out an airflow through a blowing outlet.

FIG. 6 is a diagram showing experimental results of a relationship between an average speed of a fan per an average power of the motor configured to rotate the fan and a frequency of a voltage of the motor.

FIG. 7 is a diagram illustrating a time variation of power of the motor configured to rotate the fan and a speed of the airflow.

FIG. 8 is a flowchart of the controller.

### DESCRIPTION OF EMBODIMENT

To begin with, examples of relevant techniques will be described.

An automobile air conditioning device includes an awakening detector and an air conditioner. The awakening detector is configured to detect a level of arousal of a driver for a vehicle. The air conditioner is configured to blow a conditioned air to make a thermally different environment at a part of a vehicle interior space in which the driver is located. Further, the air conditioning device includes a controller configured to control the air conditioner to operate based on detecting signals of the awakening detector to make a thermally different environment at the part of the vehicle interior space.

The air conditioning device is configured to alternately switch between a concentrated blowing state and a diffused blowing state. In the concentrated blowing state, an airflow of the conditioned air is concentrated on a center of a chest of a passenger. In the diffused blowing state, the airflow is diffused over the vehicle cabin. However, such a method may not allow the airflow to reach the passenger sufficiently.

According to one aspect of the present disclosure, an airflow generating device includes an airflow generating portion, a duct, and a controller. The airflow generating portion is configured to generate an airflow. The duct is configured to guide the airflow generated by the airflow generating portion to a blowing outlet through which the airflow is blown out toward a passenger in a vehicle cabin. The controller is configured to cause the airflow to be intermittently blown out through the blowing outlet by controlling a duty ratio of a pulse width of a pulse voltage applied to the air flow generating portion to a pulse period of the pulse voltage and a frequency of the pulse voltage.

According to the above configuration, the controller can cause the airflow to be intermittently blown out through the blowing outlet by controlling a frequency of a pulse voltage applied to the airflow generating portion and a duty ratio of a pulse width to a pulse period of the pulse voltage. Thus, more sufficient airflow can reach the passenger.

Hereinafter, embodiments of the present disclosure will be described with reference to the drawings. In the following embodiments, identical or equivalent elements are denoted by the same reference numerals as each other in the figures.

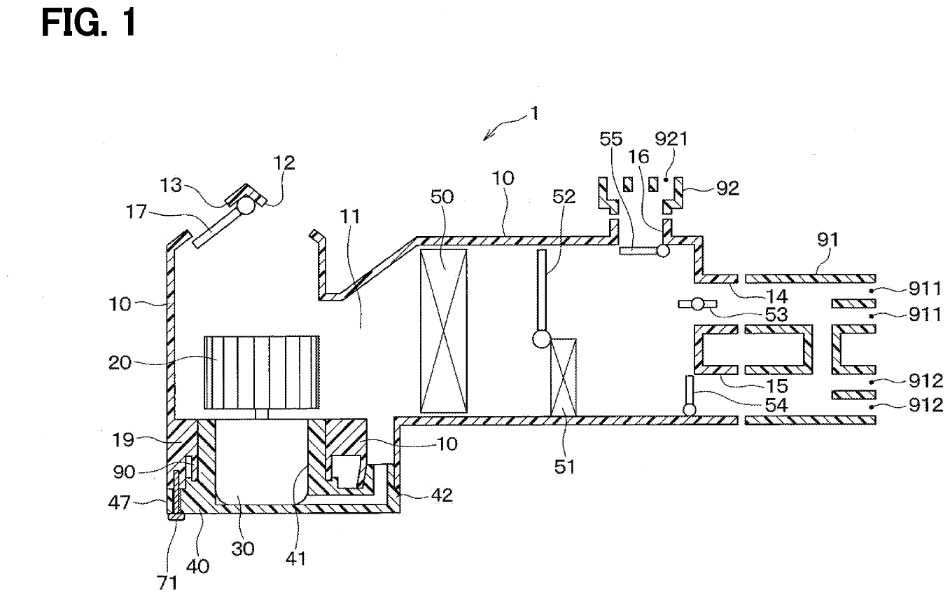

An air conditioner of an embodiment will be described with reference to FIGS. 1 to 5. The air conditioner 1 of the present embodiment is mounted in a vehicle. The air conditioner 1 is configured to condition an air in the vehicle cabin by drawing one or both of an inside air that is an air inside the vehicle and an outside air that is an air outside the vehicle, adjusting a temperature and a humidity of the drawn air, and blowing the conditioned air into the vehicle cabin.

As shown in FIG. 1, the air conditioner 1 includes an air conditioner case 10, a fan 20, a motor 30, a motor holder 40, and the like. The fan 20 and the motor 30 correspond to an airflow generating portion.

The air conditioner case 10 is made of resin having a certain degree of elasticity and excellent in strength. Examples of the resin forming the air conditioner case 10 include polypropylene. The air conditioner case 10 defines a ventilation passage 11 through which air flows into the vehicle cabin.

The air conditioner case 10 defines an inside air introducing port 12 through which the inside air is introduced into the ventilation passage 11 from a predetermined position in the vehicle cabin and an outside air introducing port 13 through which the outside air is introduced into the ventilation passage 11 from outside of the vehicle. The inside air introducing port 12 and the outside air introducing port 13 are defined at positions upstream of the ventilation passage 11 in an airflow direction. The inside air introducing port 12 and the outside air introducing port 13 may be connected to a duct (not shown) formed as a separate member from the air conditioner case 10. In this case, air is introduced from the inside air introducing port 12 or the outside air introducing port 13 into the ventilation passage 11 through the duct.

The air conditioner case 10 defines outlet openings 14, 15 and 16 at positions downstream of the ventilation passage 11 in the air flow direction for sending air from the ventilation passage 11 into the vehicle cabin. The air flowing through the ventilation passage 11 of the air conditioner case 10 is blown out into the vehicle cabin through the outlet openings 14, 15, and 16. The outlet openings 14, 15 and 16 are a face outlet opening 14, a foot outlet opening 15, and a defroster outlet opening 16. Through the face outlet opening 14, the conditioned air is blown out toward or around an upper body of a passenger seated on a front seat. Through the foot outlet opening 15, the conditioned air is blown out toward legs of the passenger. Through the defroster outlet opening 16, the conditioned air is blown out toward a windshield of the vehicle.

Each of the outlet openings 14, 15, and 16 may be connected to a duct (not shown) configured as a separate member from the air conditioner case 10. In this case, air is blown into the vehicle cabin through the outlet openings 14, 15 and 16 via the ducts.

The air conditioner case 10 houses therein an inside/outside air switching door 17, a fan 20, an evaporator 50, a heater core 51, a temperature adjusting door 52, mode switching doors 53, 54, and 55 and the like.

The inside/outside air switching door 17 is configured to continuously adjust an opening area of the inside air introducing port 12 and an opening area of the outside air introducing port 13. The inside/outside air switching door 17 is configured to rotate to close one of the inside air introducing port 12 and the outside air introducing port 13 as opening the other. Thereby, the inside/outside air switching door 17 can adjust an air volume ratio between the inside air and the outside air that are introduced into the ventilation passage 11.

The fan 20 of the present embodiment is a centrifugal fan. The fan 20 is configured to generate an airflow in the ventilation passage 11. The motor 30 configured to rotate the fan 20 is housed in a housing space 410 defined by the motor holder 40 that is fixed to the air conditioner case 10. The fan 20 is fixed to a rotational shaft of the motor 30. The fan 20 and the motor 30 configure a blower.

When the fan 20 rotates by an operation of the motor 30, an airflow is generated in the ventilation passage 11. As a result, the inside air or the outside air is introduced into the ventilation passage 11 through the inside air introducing port 12 or the outside air introducing port 13. The temperature and humidity of the air that is flown through ventilation passage 11 by the fan 20 are adjusted by the evaporator 50 and the heater core 51, and the air is blown out into the vehicle cabin through any one of the outlet openings 14, 15 and 16 that are in communication with the ventilation passage 11.

The evaporator 50 is a heat exchanger for cooling the air flowing through the ventilation passage 11. The evaporator 50 constitutes a known refrigeration cycle together with a compressor, a condenser, an expansion valve and the like (not shown). The evaporator 50 is arranged at a position downstream of the expansion valve and upstream of the compressor in the refrigeration cycle. The evaporator 50 is configured to exchange heat between a low-temperature low-pressure refrigerant flowing inside a tube (not shown) and air passing through the evaporator 50, thereby cooling the air passing through the evaporator 50 with endothermic action occurred due to latent heat of vaporization of the refrigerant.

The heater core 51 is a heat exchanger for heating the air flowing through the ventilation passage 11. The heater core 51 has a tube (not shown) through which an engine cooling water flows. The heater core 51 exchanges heat between the engine cooling water flowing through the tube and air passing through the heater core 51, thereby heating the air passing through the heater core 51.

The temperature adjusting door 52 is located between the evaporator 50 and the heater core 51. The temperature adjusting door 52 is configured to adjust a ratio between an amount of air flowing through the evaporator 50 and bypassing the heater core 51 and an amount of air flowing through both of the evaporator 50 and the heater core 51.

The mode switching doors 53, 54, and 55 are respectively provided for the face outlet opening 14, the foot outlet opening 15, and the defroster outlet opening 16 to adjust opening areas of them. The mode switching doors 53, 54, and 55 are a face door 53, a foot door 54, and a defroster door 55. The face door 53 selectively opens and closes the face outlet opening 14. The foot door 54 selectively opens and closes the foot outlet opening 15. The defroster door 55 selectively opens and closes the defroster outlet opening 16.

A duct 91 is connected to the face outlet opening 14 and the foot outlet opening 15. The face outlet opening 14 and the foot outlet opening 15 are respectively in communication with a face blowing outlet 911 and a foot blowing outlet 912 of the vehicle through the duct 91.

A duct 92 is connected to the defroster outlet opening 16. The defroster outlet opening 16 is in communication with a defroster blowing outlet 921 through the duct 92.

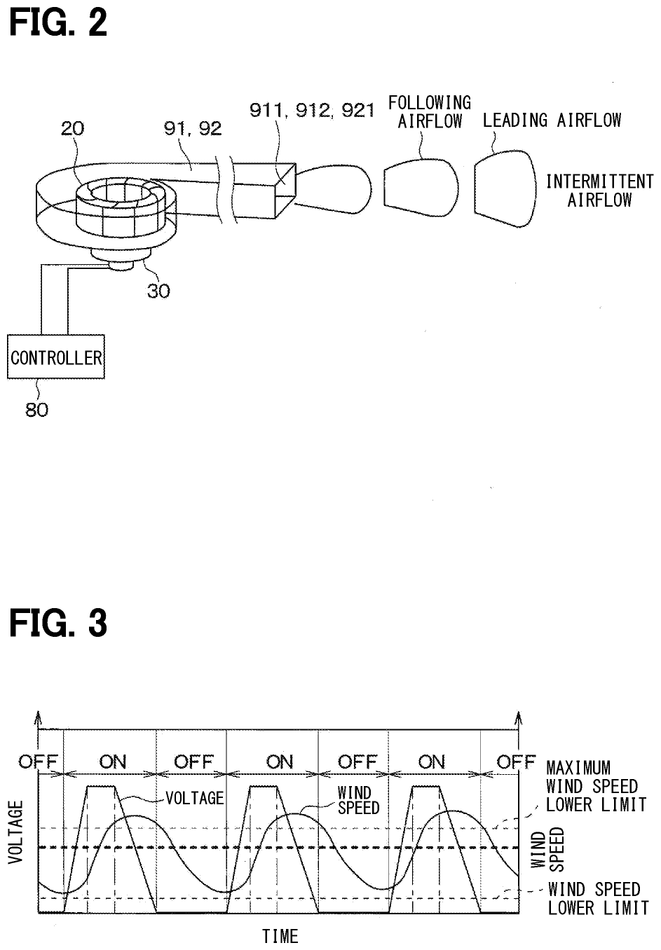

As shown in FIG. 2, the motor 30 configured to rotate the fan 20 of the air conditioner 1 of the present embodiment is controlled by a controller 80 so that the air is intermittently blown out through the face blowing outlet 911 and the foot blowing outlet 912.

The controller 80 controls a value, a frequency, and a duty ratio of the voltage applied to the motor 30 configured to rotate the fan 20 so that the air is intermittently blown out through the face blowing outlet 911 and the foot blowing outlet 912. The duty ratio is a ratio of a pulse width to a pulse period of a pulse voltage applied to the motor 30 configured to rotate the fan 20.

FIG. 3 is a time chart of a waveform of a voltage and a speed of the airflow blown out through the face blowing outlet 911 when the voltage applied to the motor 30 is turned on and off at a predetermined frequency. The higher the predetermined frequency is, the shorter the width of the waveform of the voltage is.

When the voltage rises from 0 volt to a predetermined voltage, a rotational speed of the motor 30 that rotates the fan 20 becomes faster and the speed of the airflow blown out through the face blowing outlet 911 becomes faster. There is a slight delay between time at which the voltage starts to rise and time at which the speed of the airflow reach a maximum value. This delay increases as a length of the duct 91 increases.

Then, the voltage drops from the predetermined voltage to 0 volt. As a result, the rotational speed of the motor 30 that rotates the fan 20 becomes slow and the speed of the airflow blown out through the face blowing outlet 911 becomes slow. There is a slight delay between time at which the voltage starts to drop and time at which the speed of the airflow reaches a minimum value. The speed of the airflow is controlled within a range between a predetermined lower limit, inclusive, and a maximum lower limit, non-inclusive. That is, the voltage rises again from 0 volt before the rotation of the motor 30 that rotates the fan 20 stops.

As described above, the controller 80 controls the voltage of the motor 30 configured to rotate the fan 20 and the duty ratio. The duty ratio is (on period/on period+off period)×100 shown in FIG. 3.

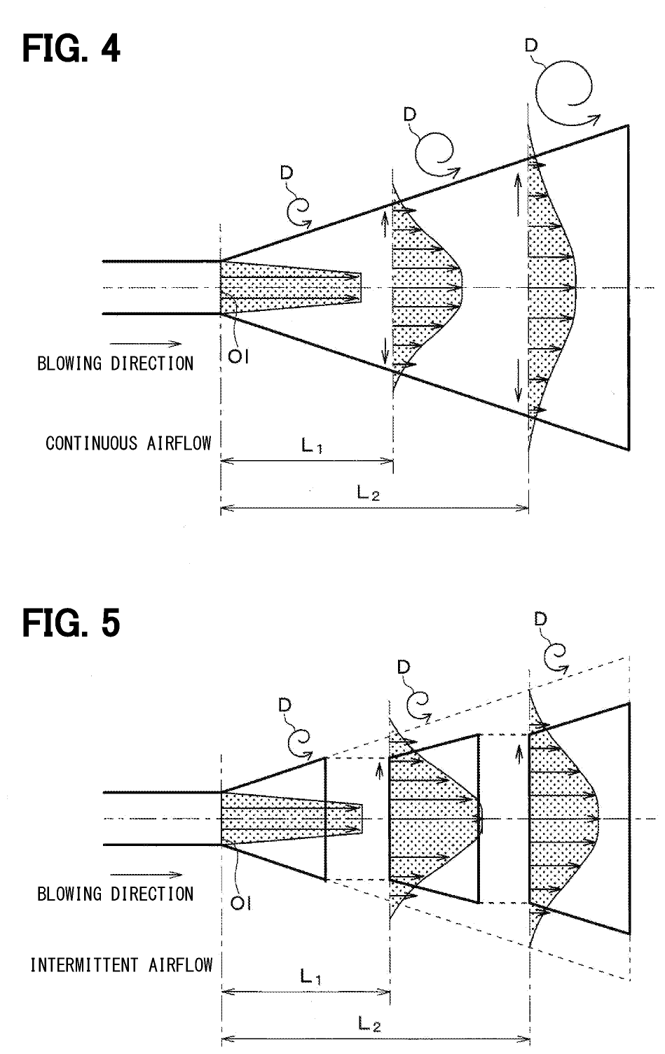

FIG. 4 is a diagram illustrating a speed distribution of an airflow in a comparative example in which an air is continuously blown out through a blowing outlet OI. FIG. 5 is a diagram illustrating a speed distribution of an airflow when the air is intermittently blown out through the blowing outlet OI as in the air conditioner of the present embodiment. The speed distribution at a position away from the blowing outlet OI by a distance L1 and the speed distribution at a position away from the blowing outlet OI by a distance L2 are illustrated. In FIGS. 4 and 5, the longer an arrow in an airflow direction in which the air is blown out through the blowing outlet OI is, the higher the speed of the airflow is.

As shown in FIG. 4, when the air is continuously blown out through the blowing outlet 01, the air is continuously supplied from a rear side of the air having flown out through the blowing outlet OI. Thus, vortices are continuously generated between the blown air and static air surrounding the blown air.

Therefore, when the vortices expand, the air blown out through the blowing outlet OI diffuses in a direction intersecting the airflow direction in which the air is blown out through the blowing outlet OI and decelerates.

This is because as a distance between the blown air and the blowing outlet OI increases, the vortex D formed in the air around the air having blown out through the outlet OI develops and expands, the developed vortex D involves the air having blown out through the blowing outlet OI. When the developed vortex D involves the air having blown out through the blowing outlet OI, the blown air diffuses and decelerates.

In contrast, as shown in FIGS. 2 and 5, when the airflow is intermittently blown out through the blowing outlet OI, the airflows are intermittently supplied from a rear side of the airflow having blown out through the outlet opening OI. Thus, vortices are discontinuously generated between the blown air and the static air around the blown air.

Thus, the airflow having blown out through the blowing outlet OI flows without diffusing much in the direction intersecting the airflow direction and with suppressing a speed of the airflow from decreasing.

This is because even if the distance from the blowing outlet OI becomes long, the vortex D generated in the air around the air having blown out through the blowing outlet OI does not develop into a large vortex, so that the vortex D is less likely to involve the air having blown out through the blowing outlet OI. When the vortex D is less likely to involve the air having blown out through the blowing outlet OI, the air having blown out through the blowing outlet OI flows without diffusing much and the speed of the airflow is restricted from decreasing.

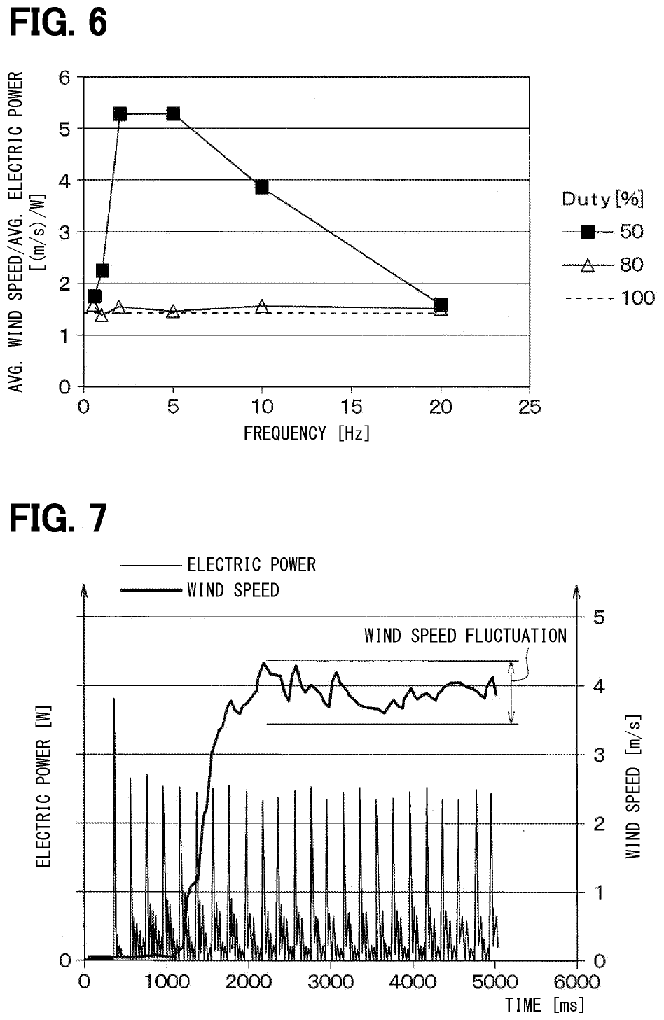

FIG. 6 is a diagram illustrating experimental results of relationship between an average speed of the fan 20 per an average power of the motor 30 at a certain position and a frequency of the voltage of the motor 30. The vertical axis represents the average speed at the certain point when the airflow is intermittently blown out with a predetermined average power. It can be said that the speed of the intermittent flow is higher and the intermittent flow is better as the value on the vertical axis increases.

The relationship when the duty ratio is set to 80% is the same as that when the duty ratio is set to 100%. Further, the airflow when the frequency of the voltage of the motor 30 is set to a value larger than 20 Hertz is the same as the continuous airflow.

For example, the air can be intermittently blown out by setting the frequency of the voltage and the duty ratio to appropriate values, for example, a value between 2 Hertz and 5 Hertz for the frequency of the voltage and 50% for the duty ratio. It is preferable to set the frequency of the voltage to a value between 0.5 Hertz, inclusive, and 20 Hertz, non-inclusive.

In addition, the duty ratio is selected within a range in which the airflow can be intermittently blown out. For example, it is preferable to set the duty ratio to 80% or less.

FIG. 7 is a diagram illustrating a time variation of the power of the motor 30 that rotates the fan 20 and a speed of the airflow. Data shown in FIG. 7 is experimental data.

The speed of the airflow is not increased immediately after applying a pulse voltage to the motor 30 configured to rotate the fan 20. After some time has elapsed since the pulse voltage was applied to the motor 30, the speed of the airflow fluctuates within a predetermined range.

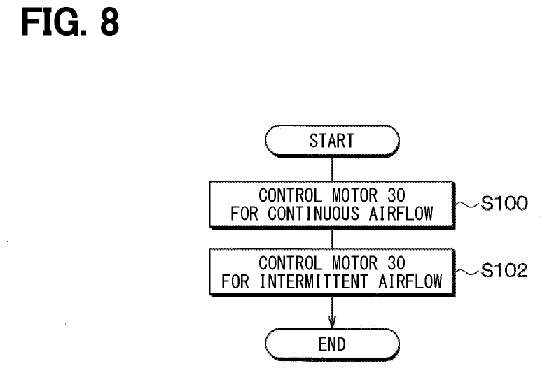

Next, a process of the controller 80 will be described with reference to FIG. 8. When the air conditioner 1 is in an operation start state, the controller 80 performs a process shown in FIG. 8. Before the start of the operation, no voltage is applied to the motor 30 configured to rotate the fan 20, thus the fan 20 is not rotating. That is, there is no airflow.

First, in S100, the controller 80 is configured to output a constant voltage to the motor 30 configured to rotate the fan 20 so that the continuous airflow is blown out through the face blowing outlet 911 for a predetermined period. Specifically, a constant voltage with a duty ratio of 100% is output to the motor 30.

Next, in S102, when the predetermined period has elapsed, the controller 80 is configured to periodically output a pulse voltage to the motor 30 that rotates the fan 20 so that the intermittent airflow is blown out through the face blowing outlet 911. For example, the controller 80 is configured to periodically output a pulse voltage with 10 Hertz of the frequency and 50% of the duty ratio. As a result, the fan 20 intermittently blows out the air. The motor 30 is controlled by the controller 80 so that the speed of the intermittent airflow blown out through the face blowing outlet 911 falls within a predetermined speed range.

As described above, the air flow generating device of the present embodiment includes an airflow generating portion 20, 30 and a duct 91. The airflow generating portion 20, 30 is configured to generate an airflow. The duct 91 is configured to guide the airflow generated by the airflow generating portion 20, 30 to a blowing outlet 911, 912 through which the airflow is blown out toward a passenger in a vehicle cabin. The airflow generating device further includes a controller 80 configured to cause the airflow to be intermittently blown out through the blowing outlet 911, 912 by controlling a duty ratio of a pulse width of a pulse voltage applied to the airflow generating portion 20, 30 to a pulse period of the pulse voltage and a frequency of the pulse voltage.

According to the above configuration, the controller 80 is configured to cause the airflow to be intermittently blown out through the blowing outlet 911, 912 by controlling the frequency of a pulse voltage applied to the airflow generating portion 20, 30 and the duty ratio of the pulse width to the pulse period of the pulse voltage. Therefore, more sufficient airflow can reach the passenger.

The controller 80 is configured to control the frequency of the pulse voltage between 0.5 Hertz and 20 Hertz. As described above, by controlling the frequency of the pulse voltage within a range between 0.5 Hz and 20 Hz, it is possible to intermittently blow out the airflow through the blowing outlet 911, 912.

The controller 80 is further configured to control the duty ratio within a particular range such that the airflow is intermittently blown out through the blowing outlet 911, 912. In this way, the controller 80 can control the duty ratio within the particular range such that the airflow is intermittently blown out through the blowing outlet 911, 912.

The controller 80 is further configured to continuously blow out the airflow through the blowing outlet 911, 912 by controlling the frequency of the pulse voltage applied to the airflow generating portion 20, 30 and the duty ratio for a predetermined period after starting an operation. After that, the controller 80 is further configured to intermittently blow out the airflow through the blowing outlet 911, 912 by controlling the frequency of the pulse voltage applied to the airflow generating portion 20, 30 and the duty ratio.

Therefore, after the operation is started, the airflow can reach the passenger immediately and then a sufficient airflow can reach the passenger.

The controller 80 and methods described in the present disclosure may be implemented by one or more special-purpose computers. Such computers may be created by: (i) configuring a processor and a memory coupled to the processor and storing instructions that when executed by the processor cause the processor to execute one or more particular functions; (ii) configuring a processor provided by one or more special purpose hardware logic circuits; or (iii) configuring a combination of a memory and a processor programmed to execute one or more particular functions embodied in computer programs and a processor provided by one or more hardware logic circuits.

### Other Embodiments

(1) In the above embodiment, a predetermined pulse voltage is periodically applied to the motor 30 such that an airflow is intermittently blown out through the face blowing outlet 911, the foot blowing outlet 912, and the defroster blowing outlet 921 of the vehicle.

In contrast, shutters (not shown) may be attached to the face outlet opening 14, the foot outlet opening 15, and the defroster outlet opening 16. Then, these shutters may be selectively opened and closed such that the airflow is intermittently blown out through the face blowing outlet 911, the foot blowing outlet 912, and the defroster blowing outlet 921 of the vehicle.

(2) The controller 80 of the above embodiment is configured to control both of the frequency of the pulse voltage applied to the airflow generating portion 20, 30 and the duty ratio such that the airflow is intermittently blown out through the blowing outlets 911, 912.

In contrast, the controller 80 may be configured to control at least one of the frequency of the pulse voltage applied to the airflow generating portion 20, 30 and the duty ratio such that the airflow is intermittently blown out through the blowing outlet 911, 912.

The present disclosure is not limited to the above-described embodiments, and can be appropriately modified. Individual elements or features of a particular embodiment are generally not limited to that particular embodiment, but, where applicable, are interchangeable and can be used in a selected embodiment, even if not specifically shown or described. Further, in each of the above-mentioned embodiments, it goes without saying that components of the embodiment are not necessarily essential except for a case in which the components are particularly clearly specified as essential components, a case in which the components are clearly considered in principle as essential components, and the like. A quantity, a value, an amount, a range, or the like, if specified in the above-described example embodiments, is not necessarily limited to the specific value, amount, range, or the like unless it is specifically stated that the value, amount, range, or the like is necessarily the specific value, amount, range, or the like, or unless the value, amount, range, or the like is obviously necessary to be the specific value, amount, range, or the like in principle. Further, in each of the embodiments described above, when materials, shapes, positional relationships, and the like, of the components and the like, are mentioned, they are not limited to these materials, shapes, positional relationships, and the like, unless otherwise specified and unless limited to specific materials, shapes, positional relationships, and the like.

### (Overview)

According to the first aspect shown in a part or all of the above embodiments, an air flow generating device includes an airflow generating portion, a duct, and a controller. The airflow generating portion is configured to generate an airflow. The duct is configured to guide the airflow generated by the airflow generating portion to a blowing outlet through which the airflow is blown out toward a passenger in a vehicle cabin. The controller is configured to cause the airflow to be intermittently blown out through the blowing outlet by controlling a duty ratio of a pulse width of a pulse voltage applied to the airflow generating portion to a pulse period of the pulse voltage and a frequency of the pulse voltage.

According to the second aspect, the controller is configured to control the frequency of the pulse voltage between 0.5 and 20 Hertz. By controlling the frequency of the pulse voltage between 0.5 Hz and 20 Hz, it is possible to intermittently blow out the airflow through the blowing outlet.

According to the third aspect, the controller is configured to control the duty ratio within a particular range such that the airflow is intermittently blown out through the blowing outlet. Thereby, the controller can control the duty ratio within the particular range such that the airflow is intermittently blown out through the blowing outlet.

According to a fourth aspect, the controller is configured to continuously blow out the airflow thorough the blowing outlet by controlling the duty ratio and the frequency of the pulse voltage applied to the airflow generating portion for a predetermined period after starting an operation. After that, the controller is configured to intermittently blow out the airflow thorough the duty ratio and the frequency of the pulse voltage applied to the airflow generating portion.

Therefore, after the operation is started, the airflow can reach the passenger immediately and then a sufficient airflow can reach the passenger.

The fan 20 and the motor 30 correspond to the airflow generating portion. That is, the airflow generating portion corresponds to a blower.

What is claimed is:

1. An airflow generating device comprising:
an airflow generating portion configured to generate an airflow;
a duct configured to guide the airflow generated by the airflow generating portion to a blowing outlet through which the airflow is blown out toward a passenger in a vehicle cabin; and
a controller configured to cause the airflow to be intermittently blown out through the blowing outlet by controlling a frequency of a pulse voltage applied to the air flow generating portion and a duty ratio of a pulse width to a pulse period of the pulse voltage, wherein
the controller is configured to control the frequency of the voltage and the duty ratio such that the airflow is blown out through the blowing outlet at a speed between a predetermined lower limit, inclusive, and a maximum lower limit, non-inclusive, which is greater than the lower limit.

2. The airflow generating device according to claim 1, wherein
the controller is configured to control the frequency of the pulse voltage between 0.5 Hertz and 20 Hertz.

3. The airflow generating device according to claim 1, wherein
the controller is configured to control the duty ratio within a particular range such that the airflow is intermittently blown out through the blowing outlet.

4. The airflow generating device according to claim 1, wherein
the controller is configured to:
continuously blow out the airflow through the blowing outlet by controlling the duty ratio and the frequency of the pulse voltage applied to the airflow generating portion for a predetermined period from a start of operation; and then
intermittently blow out the airflow through the blowing outlet by controlling the duty ratio and the frequency of the pulse voltage applied to the airflow generating portion.

5. A controller comprising:
a processor; and
a memory coupled to the processor and storing instructions that when executed by the processor cause the processor to at least:
control a blower to intermittently blow out an airflow through a blowing outlet toward a passenger in a vehicle cabin at a speed between a predetermined lower limit, inclusive, and a maximum lower limit, non-inclusive, which is greater than the lower limit by controlling (i) a frequency of a pulse voltage applied to the blower and (ii) a duty ratio of a pulse width to a pulse period of the pulse voltage.

6. A method implemented by a processor, comprising:
controlling a blower to intermittently blow out an airflow through a blowing outlet toward a passenger in a vehicle cabin at a speed between a predetermined lower limit, inclusive, and a maximum lower limit, non-inclusive, which is greater than the lower limit by controlling (i) a frequency of a pulse voltage applied to the blower and (ii) a duty ratio of a pulse width to a pulse period of the pulse voltage.
